(19) United States
(12) Patent Application Publication
(10) Pub. No.: US 2024/0337284 A1
(43) Pub. Date: Oct. 10, 2024

(54) THREADED ELEMENT WHICH COMPRISES OR CONSISTS OF A METAL AND WHICH HAS AN INTERNAL THREAD

(71) Applicant: Heraeus Amloy Technologies GmbH, Hanau (DE)

(72) Inventors: Beytullah Yasin KILIC, Hanau (DE); Ronald Allan ROSENBERGER, Hanau (DE); Hans Jürgen WACHTER, Karlstein (DE); Elena BIEN, Karlstein (DE); Tim GLÄSER, Karlstein (DE)

(21) Appl. No.: 18/579,154

(22) PCT Filed: Jul. 4, 2022
(86) PCT No.: PCT/EP2022/068367

§ 371 Date: Jan. 12, 2024

(30) Foreign Application Priority Data
Jul. 16, 2021 (EP) 21186163.8

(51) Int. Cl. F16B 37/08; B22F 5/06; B22F 10/28; B33Y 10/00; B33Y 80/00

(52) U.S. Cl. CPC F16B 37/0828; B22F 5/06; B22F 10/28; B33Y 10/00; B33Y 80/00

(57) ABSTRACT

A threaded element comprising or consisting of a metal having an internal thread which is produced by additive manufacturing, and to a method for producing a threaded element comprising or consisting of a metal having an internal thread. The threaded element comprises a body, an opening that defines an inner wall of the body, and a threaded section having a thread. The body comprises a first end and a second end. The opening extends at least partially from the first end toward the second end of the body. The threaded section is formed on the inner wall of the opening, and the inner wall has at least one recess which crosses the threaded section. A surface of the threaded section has a roughness R_{z} in the range of 5-50 μm, in particular 10-25 μm.

### TECHNICAL FIELD

The present invention relates to a threaded element comprising or consisting of a metal having an internal thread which is produced using an additive manufacturing method, and to a method for producing a threaded element comprising or consisting of a metal having an internal thread.

### BACKGROUND OF THE INVENTION

The term amorphous metals is used if metal alloys have, at an atomic level, an amorphous rather than a crystalline structure. Such a disordered structure is usually achieved by rapid cooling of a melt. “Rapid cooling” means that the atoms or molecules can no longer arrange themselves in a regular pattern during cooling.

Amorphous metal alloys and/or precious metals exhibit excellent mechanical properties such as high corrosion resistance, isotropic properties, high magnetic permeability and biocompatibility. Amorphous alloys and/or precious metals are therefore well suited for high-tech applications.

In general, an internal thread of a component is produced by machining threads, e.g. by cutting or milling. However, due to its hardness, the component comprising amorphous alloys cannot easily be machined, which can lead to imprecision of the internal thread produced and/or technical effort. It is therefore very laborious to manufacture the component from amorphous alloys having a complex internal structure using a conventional process. The use of additive manufacturing methods for components made of precious metals has the advantage that expensive waste which arises while machining threads can be avoided.

### SUMMARY OF THE INVENTION

It is therefore an object of the present invention to provide an improved threaded element having an internal thread which can be produced by means of a simplified method.

This object is achieved by the threaded element comprising or consisting of a metal with an internal thread, which is produced using an additive manufacturing method, and by the method for producing a threaded element comprising or consisting of a metal having an internal thread according to the independent claims. Advantageous embodiments and developments can be found in the dependent claims and the following description.

The present invention comprises a threaded element comprising or consisting of a metal having an internal thread, which is produced using an additive manufacturing method. The threaded element comprises a body, an opening that defines an inner wall of the body, and a threaded section having a thread. The body comprises a first end and a second end. The opening extends at least partially from the first end toward the second end of the body. The threaded section is formed on the inner wall of the opening, and the inner wall has at least one recess which crosses the threaded section. A surface of the threaded section has a roughness R_{z} in the range of 2.5-60 μm, in particular 10-25 μm.

The advantage of the present invention is that a thread, in particular a self-tapping internal thread of a workpiece such as a threaded element made of amorphous alloys and/or precious metals, can be produced without great effort. In additive manufacturing, a powder material of metal, for example amorphous alloys and/or precious metals, can be applied in layers and selectively melted so that a predefined dimension and/or structure of the internal thread and/or threaded element to be produced can be produced without any problems. In this way, a threaded element made of metal, for example amorphous alloys and/or precious metals, with a functional internal thread can be produced in an energy-efficient and economical manner. A further advantage of the threaded element according to the invention is the lack of post-processing of the threaded element produced.

Additive manufacturing is a broad generic term that encompasses a variety of different manufacturing techniques. What they all have in common is that they enable the production of workpieces of almost any complexity by solidifying material layer by layer.

The additive manufacturing method can be selected from the group consisting of selective laser melting (SLM), selective electron beam melting (SEBM), laser metal deposition (LMD) and selective laser sintering (SLS).

The threaded element can comprise or consist of a metal material. In other words, the metal powder material is applied in layers and selectively melted using the additive manufacturing method in order to produce the threaded element that has an internal thread.

The shape of the body cannot be limited to a specific design. The body can have, for example, a complex contour which can be suitable for use in medical technology, fine mechanics and/or aerospace. The body of the threaded element can, for example, be cylindrical, block-shaped or annular.

The body can have an opening which extends at least partially from one end of the body into a center of the body. The opening can be formed along a longitudinal axis of the body or perpendicularly or obliquely to the longitudinal axis of the body. The opening can extend either only up to a predetermined depth of the body or continuously from the first end to the second end of the body in order to form a passage. The opening can have a circular, square, rectangular, elliptical or polygonal cross section.

By means of the opening arranged in the interior of the body, the body can have an inner wall through. The cross section of the inner wall can therefore be the same as the cross section of the opening. The threaded section can be formed on the inner wall of the body or the opening and comprise a plurality of thread turns.

In contrast to machining threads where the opening and the threaded section are produced on an existing body, the body, the opening and the threaded section of the threaded element according to the invention can be produced in one step using the additive manufacturing method. In other words, the metal powder material can be selectively melted using an electron beam or laser beam, for example, in order to produce the body and the threaded section of the threaded element. An opening, a recess and/or a groove can therefore be created at the point where the powder material is not exposed to a beam. The recess may constitute at least 10%, or at least 25%, or at least 50% of the circumference of the opening.

The at least one recess can be formed substantially in the longitudinal direction of the threaded section. Alternatively or additionally, the at least one recess can be formed substantially in the circumferential direction of the threaded section. The recess can be designed to divide or cross the threaded section. In other words, thread turns of the threaded section can be interrupted by the recess. The recess can serve to receive excess powder material which is produced during the additive manufacturing process and adheres to the thread turn, in particular when a screw is screwed into this thread.

The recess can have a cross section of any shape, in particular triangular, rectangular, (semi)circular or polygonal. The recess can have the same length as the threaded section or only partially cross the threaded section. According to the invention, the depth of the recess is not further limited either.

In one embodiment, a transitional section can be located between the recess and the thread of the threaded section. The transitional section can have an angle relative to the recess, wherein the angle is preferably between 90° and 270°.

Furthermore, the threaded section can possess a certain surface property of the shaped internal thread by using the additive manufacturing method. The surface of the threaded section, in particular the surface of the thread turns which serves as a contact surface with a mating element, such as a screw, can therefore have a certain roughness. The roughness R_{z} can be an average value from individual roughness depths in the roughness profile of the threaded section, wherein the roughness can be measured according to DIN EN ISO 1302:2002-06. The surface of the threaded section can therefore have an average roughness in the region of at least 2.5 μm, in particular at least 10 μm. A surface of the threaded section has a roughness R_{z} in the range of at most 75 μm, in particular at most 50 μm, and particularly preferably at most 25 μm.

In one embodiment, an outer diameter of the thread is at least 0.5 mm. The outer diameter of the thread of the threaded section has no further upper limit. However, the outer diameter of the thread can be smaller than the diameter of the body of the threaded element in order to be able to establish a threaded section on the inner wall of the body. The outer diameter of the thread can, for example, be 12 mm in order to be able to receive an M12 screw.

In one embodiment, the metal is selected from the group consisting of amorphous alloys and/or precious metals. Particularly preferred are amorphous alloys having a Vickers hardness HV5 in the region of 300 or more, in particular 400 or more. In other words, the threaded element can be produced by selectively melting a metal powder material comprising or consisting of amorphous alloys and/or precious metals.

The amorphous metal alloys exhibit excellent mechanical properties, high corrosion resistance, isotropic properties, high magnetic permeability and good biocompatibility. The amorphous alloys and/or precious metals are therefore well suited for high-tech applications. Precious metals have, inter alia, high corrosion resistance and good biocompatibility.

However, due to its hardness and its high elastic elongation, a component that comprises amorphous alloys cannot be easily machined, which can lead to imprecision of the internal thread produced. Additive manufacturing methods enable an energy-efficient and economical production of the threaded element with an internal thread made of a metal comprising or consisting of amorphous alloys and/or precious metals.

Amorphous alloys can have a metal bonding character in the solid state and at least one non-crystalline phase at the same time. The absence of crystalline phases can be determined using XRD. A phase is considered amorphous if no peaks are apparent in the diffractogram. In a particular embodiment, amorphous alloys are also to be understood as those which have at least one nanocrystalline phase. Amorphous alloys can therefore be referred to as bulk metal glasses. The amorphous alloy can be based on different elements. “Based” in this context means that the element named in each case represents the largest proportion in relation to the weight of the alloy. Components that preferably form a basis of such an alloy may be selected, for example, from:
A. metals from group IA and IIA of the periodic table, e.g., magnesium, calcium,
B. metals from Group IIIA and IVA, e.g., aluminum or gallium,
C. early transition metals from groups IVB to VIIIB, such as titanium, zirconium, hafnium, niobium, tantalum, chromium, molybdenum, manganese,
D. late transition metals from groups VIIIB, IB, IIB, such as iron, cobalt, nickel, copper, palladium, platinum, gold, silver, zinc,
E. rare earth metals, such as scandium, yttrium, terbium, lanthanum, cerium, neodymium, gadolinium, and
F. non-metals, such as boron, carbon, phosphorus, silicon, germanium, sulfur.

Preferred combinations of elements in bulk metallic glasses are selected from:
late transition metals and nonmetals, wherein the late transition metal is the base, for example Ni—P, Pd—Si, Au—Si—Ge, Pd—Ni—Cu—P, Fe—Cr—Mo—P—C—B,
early and late transition metals, wherein both metals may be the base, such as Zr—Cu, Zr—Ni, Ti—Ni, Zr—Cu—Ni—Al, Zr—Ti—Cu—Ni—Be,
metals from group B with rare earth metals, wherein metal B is the base, such as Al—La, Al—Ce, Al—La—Ni—Co, La—(Al/Ga)—Cu—Ni, and
metals from group A with late transition metals, wherein metal A is the base, such as Mg—Cu, Ca—Mg—Zn, Ca—Mg—Cu

Other particularly preferred examples of alloys forming bulk metal glasses are selected from the group consisting of Ni—Nb—Sn, Co—Fe—Ta—B, Ca—Mg—Ag—Cu, Co—Fe—B—Si—Nb, Fe—Ga—(Cr,Mo)(P,C,B), Ti—Ni—Cu—Sn, Fe—Co-Ln-B, Co—(Al,Ga)—(P,B,Si), Fe—B—Si—Nb and Ni—(Nb, Ta)—Zr—Ti. In particular, the bulk metallic glass may be a Zr—Cu—Al—Nb alloy. Preferably, in addition to zirconium, this Zr—Cu—Al—Nb alloy comprises 23.5-24.5% by weight of copper, 3.5-4.0% by weight of aluminum, and 1.5-2.0% by weight of niobium, wherein the weight percentages add up to 100% by weight.

In another particularly preferred embodiment, the bulk glass-forming alloy may contain or consist of the elements zirconium, titanium, copper, nickel, and aluminum. Another particularly suitable alloy has the composition Zr_{52.5}Ti₅Cu_{17.9}Ni_{14.6}Al₁₀, wherein the indices indicate mol % of the respective elements in the alloy.

In one embodiment, the recess and/or the thread comprises a bevel at the first end and/or the second end of the body. The threaded section can have a first bevel at least at the first end of the body in which the opening is provided. If the opening in the body extends from the first end to the second end of the body so that a passage can be formed, the threaded section can additionally have another bevel at the second end of the body.

The term bevel can be understood to mean that a free workpiece edge is beveled so that an angular edge of the workpiece can be removed. A sharp edge at the first end and/or the second end of the body can therefore be avoided, and at the same time a mating element, such as a screw, which is screwed into the bore, can be inserted more easily.

In one embodiment, the thread comprises a plurality of thread turns which have a flank angle of 10° to 70°. The thread can be formed around the longitudinal axis of the body. The thread can have a plurality of thread turns which extend at least partially from the first end to the second end of the body. The term flank angle can be understood to mean an angle between the facing flanks of a thread turn or of the two adjacent thread turns. The flank angle of the thread turn can be kept constant or vary along the thread.

In one embodiment, the threaded section has a conical shape relative to the longitudinal axis of the opening. The threaded section can be conical within the body of the threaded element. In other words, a flank diameter, an outer diameter and/or a core diameter of the threaded section can gradually be increased or reduced along the longitudinal axis of the opening. Alternatively, the height of the thread turns along the longitudinal axis can decrease or increase without changing the outer diameter of the thread of the threaded section.

In one embodiment, the inner wall of the body has a plurality of recesses which extend at least partially from the first end toward the second end of the opening. The recesses can extend along the inner wall of the body from the first end to the second end of the opening. The recesses are preferably arranged from the inner wall out in the radial direction of the threaded section. The recesses can be arranged at a distance from one another in the circumferential direction of the opening. The recesses can constitute at least 10%, or at least 25%, or at least 50% of the circumference of the opening. In this way, the recesses can cross the threaded section and interrupt the course of the threaded section. The excess metal powder which originates from the additive manufacturing method and adheres to the thread turn can be accommodated in the recesses.

In an embodiment, the recess is formed helically along the threaded section. The helical recess can be arranged along the inner wall of the body substantially in the same direction as the thread of the threaded section. However, the helical recess can also be arranged along the inner wall of the body substantially in the opposite direction to the thread of the threaded section. However, the recess cannot comprise any thread turns.

A width of the recess can be significantly greater than a pitch of the thread which corresponds to a distance between the tips of the thread turns. Furthermore, a diameter of the recess can be significantly larger than the outer diameter of the thread so that the recess further penetrates the body from the inner wall out than the threaded section. In this way, the recess can cross the threaded section and interrupt the course of the threaded section. The excess metal powder which originates from the additive manufacturing method and adheres to the thread turn can be accommodated in the recess.

In one embodiment, the recess comprises a counter thread which is formed at least partially in the opposite direction to the thread of the threaded section. In other words, the recess can form a second threaded section together with the counter thread, which second threaded section is arranged in the opposite direction to the first thread of the first threaded section. That is to say, two opposing threaded sections which cross each other can be formed on the inner wall of the body. The excess metal powder which originates from the additive manufacturing method and adheres to the thread turn can be accommodated in the recess. One advantage of this embodiment is that both right-hand and left-hand screws can be screwed into the internal thread. The other thread then serves as a recess.

In one embodiment, the recess extends substantially in the longitudinal direction of the opening, wherein portions of the recess are offset in the radial direction of the opening. The recess can have an elongate shape extending from the first end toward the second end of the opening, and the elongate shape can comprise a plurality of sections. Each section of the recess can have a different distance between the particular section of the recess and the longitudinal axis of the opening so that portions of the recess are offset in the radial direction of the opening. In this way, the recess can cross the threaded section and interrupt the course of the threaded section. The excess metal powder which originates from the additive manufacturing method and adheres to the thread turn can be accommodated in the recess.

In one embodiment, a base width of the thread turns varies along the thread. Alternatively, the thread turns along the thread can have a different height so that the flank diameter of the thread changes along the longitudinal axis. Additionally or alternatively, a thread pitch can vary between the facing flanks of the two adjacent thread turns along the threaded section. In this way, the recess can be integrated in the threaded section. The excess metal powder which originates from the additive manufacturing method and adheres to the thread turn can be accommodated in the recess.

The present invention further comprises a method for producing a threaded element comprising or consisting of a metal having an internal thread. The threaded element comprises a body, an opening which defines an inner wall of the body and a threaded section. The body comprises a first end and a second end. The opening extends at least partially from the first end toward the second end of the body. The threaded section is formed on the inner wall of the opening, and the inner wall has at least one recess which crosses the threaded section. The surface of the threaded section has a roughness R_{z} in the range of 2.5-60 μm, in particular 10-25 μm. The threaded element is produced using an additive manufacturing method.

In one embodiment, the additive manufacturing method is selected from the group consisting of selective laser melting (SLM), selective electron beam melting (SEBM), laser metal deposition (LMD) and selective laser sintering (SLS).

In this way, a threaded element having an internal thread made of amorphous alloys and/or precious metals can be produced. In general, amorphous alloys are difficult to machine due to their hardness and high elastic elongation, especially when cutting threads by machining. However, amorphous alloys exhibit excellent mechanical properties, high corrosion resistance, isotropic properties, high magnetic permeability and biocompatibility. Amorphous alloys and/or precious metals are therefore well suited for high-tech applications.

By means of additive manufacturing, such materials can be used without problems to produce a complex component. The threaded element comprising the internal thread and recesses can therefore be formed by targeted layer application of the metal powder material comprising or consisting of amorphous alloys and/or precious metals. A further advantage of the method according to the invention is the lack of post-processing for the threaded element produced.

In one embodiment, the recess is designed to receive excess material from a thread turn when a screw is screwed in. In this way, the metal powder material which adheres to the thread turn produced can be accommodated in the recess that crosses or divides the thread when a screw is screwed into the internal thread. A functional internal thread section of a threaded element can therefore be produced, in particular if the thread is formed from an amorphous alloy and was produced using additive manufacturing.

In one embodiment, the method can further comprise the following steps:
providing the metal powder material by melting, atomizing and sifting a raw material comprising or consisting of amorphous alloys and/or precious metals, and
applying the metal powder material in layers and
selective melting using an additive manufacturing method.

In the additive manufacturing method, the powder material produced can be applied in layers, for example in an SLM (selective laser melting) production system without preheating the powder. A laser power of 100-200 W with a scanning speed of 1500-3000 mm/s can be used. In the case of amorphous alloys, melting zones of the individual layers solidify so rapidly that crystallization of the melted alloy is prevented, and the alloy can solidify amorphously. The laser power, the scanning speed and the hatch distance must be selected depending on the layer thickness, the powder grain diameter and the alloy type such that the cooling rate of the melt of the alloy lies below the critical cooling rate of the relevant material. A person skilled in the art of additive manufacturing can adjust these parameters without exercising inventive skill.

Further features, advantages and possible applications of the present invention can be found in the following description, the embodiments and the drawings. All described and/or graphically illustrated features can be combined with one another independent of their representation in individual claims, drawings, sentences or paragraphs. In the drawings, the same reference signs represent identical or similar objects.

### BRIEF DESCRIPTION OF THE DRAWINGS

FIG. 1 shows a threaded element according to one embodiment of the present invention.

FIG. 2 shows a plan view of a threaded element according to one embodiment of the present invention.

FIG. 3 shows a schematic cross section of a threaded element according to one embodiment of the present invention.

FIG. 4 shows a schematic cross section of a threaded element according to one embodiment of the present invention.

FIG. 5 shows a schematic cross section of a threaded element according to another embodiment of the present invention.

FIG. 6a shows a schematic cross section of a threaded element according to another embodiment of the present invention.

FIG. 6b shows a plan view of a threaded element according to another embodiment of the present invention.

FIG. 7 shows a schematic cross section of a threaded element according to another embodiment of the present invention.

FIG. 8 shows a schematic cross section of a threaded element according to another embodiment of the present invention.

FIG. 9a shows a schematic cross section of a threaded element according to another embodiment of the present invention.

FIG. 9b shows a schematic cross section of a threaded element according to another embodiment of the present invention.

### DETAILED DESCRIPTION OF THE EMBODIMENTS

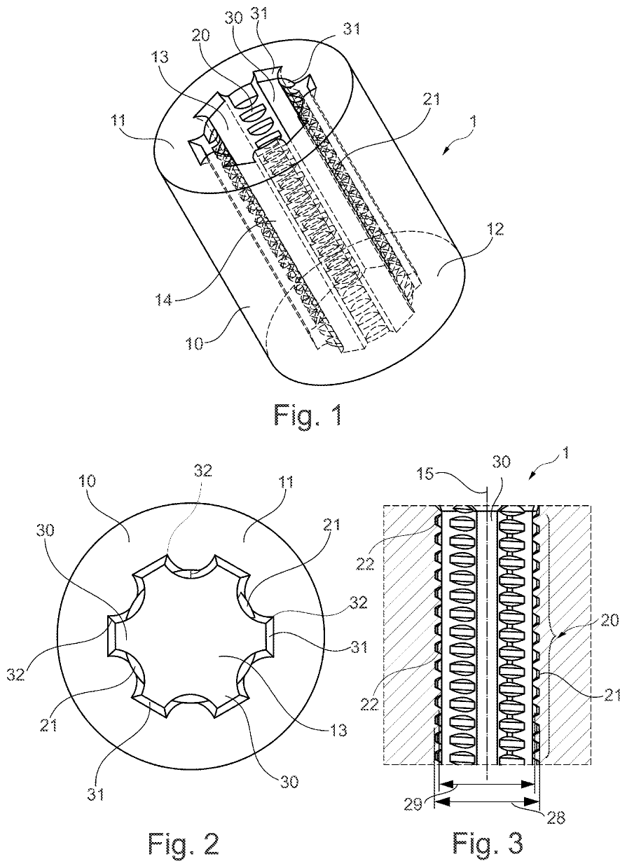

FIG. 1 shows the threaded element 1 according to the invention with an internal thread. The threaded element 1 comprises or consists of a metal. The threaded element 1 can be produced using an additive manufacturing method. The metal is selected from the group consisting of amorphous alloys and/or precious metals. The additive manufacturing method is selected from the group consisting of selective laser melting (SLM), selective electron beam melting (SEBM), laser metal deposition (LMD) and selective laser sintering (SLS).

The threaded element 1 comprises a body 10, an opening 13 which defines an inner wall 14 of the body 10, and a threaded section 20. The body 10 comprises a first end 11 and a second end 12. The opening 13 extends at least partially from the first end 11 toward the second end 12 of the body 10.

The threaded section 20 is formed on the inner wall 14 of the opening 13. The threaded section comprises a thread 21 having a plurality of thread turns 22 (see also FIG. 3). In this way, the threaded section 20 defines the thread 21 of the threaded element 1. A surface of the threaded section 20 has a roughness R_{z} in the region of at least 2.5 μm, in particular 10 μm. A surface of the threaded section 20 has a roughness R_{z} in the region of at most 75 μm, in particular 50 μm and particularly preferably 25 μm. The inner wall 14 of the body 10 has at least one recess 30 which crosses the threaded section 20. The recess 30 is designed to receive excess material from the region between the thread turns 22 when a screw is screwed in.

As shown in FIG. 2, the recess 30 and/or the threaded section 20 comprise(s) a bevel 31 at the first end 11 and/or the second end 12 of the body 10. Furthermore, a transitional section 32 is located between the recess 30 and the thread 21. The transitional section 32 typically has an angle relative to the recess 30 which is between 9° and 270°. The inner wall 14 of the body 10 has a plurality of recesses 30 which extend at least partially from the first end 11 toward the second end 12 of the opening 13. The recesses 30 are spaced apart from one another in the circumferential direction of the threaded section 20.

FIG. 3 shows a cross section of the threaded element 1. The threaded element 1 comprises the threaded section 20 with the thread 21, wherein the thread 21 comprises a plurality of thread turns 22. The threaded section 20 extends along the longitudinal axis 15 of the body 10 or the opening 13. The thread 21 has an outer diameter 28 and a flank diameter 29. The outer diameter 28 of the thread 21 can, for example, be at least 0.5 mm.

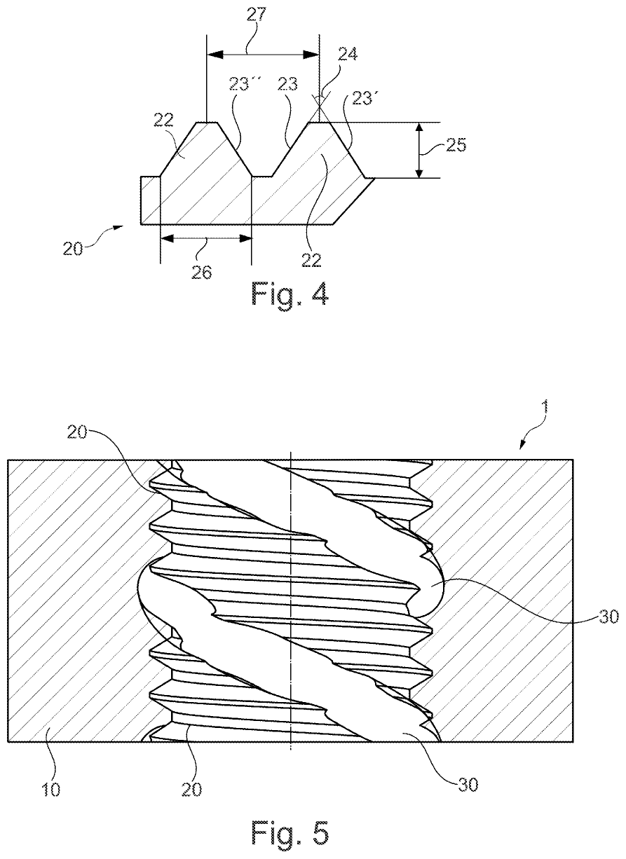

FIG. 4 shows a cross section of the threaded section 20. Each thread turn 22 consists of two flanks 23, 23′, which collectively define a flank angle 24. The flank angle 24 can be between 10° and 70°. Furthermore, each thread turn 22 has a thread turn height 25 and a base width 26. Furthermore, a distance between two thread turns is referred to as a thread pitch 27.

FIG. 5 shows the threaded section 20 with the recess 30 which is shaped helically along the threaded section 20. The helical recess 30 can be arranged along the inner wall 14 of the body substantially in the same direction as the thread 21 of the threaded section 20. However, the helical recess 30 can also be arranged along the inner wall 14 of the body 10 substantially in the opposite direction to the thread 21 of the threaded section 20. However, in this case, the recess 30 does not comprise any thread turns.

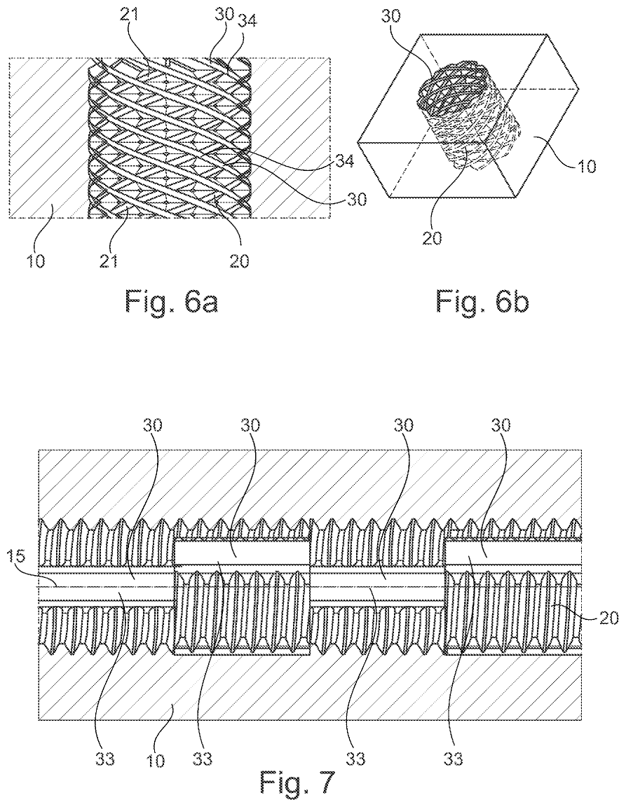

FIG. 6a shows the threaded section 20 with the recess 30 which comprises a counter thread 34 which is formed at least partially in the opposite direction to the thread 21 of the threaded section 20. FIG. 6b shows the threaded element 1 comprising this threaded section 20. That is to say, two opposite threads 21, 34 which cross one another are formed in the threaded section on the inner wall 14 of the body 10.

FIG. 7 shows the threaded section 20 comprising the recess 30 which extends substantially in the longitudinal direction of the opening 13 and portions of which are displaced in the radial direction of the opening 13. The recess 30 has an elongate shape which extends from the first end 11 toward the second end 12 of the opening 13, and the elongate shape comprises a plurality of sections 33. Each section 33 of the recess 30 has a different distance between the particular section 33 of the recess 30 and the longitudinal axis 15 of the opening 13 so that portions of the recess 30 are offset in the radial direction of the opening 13.

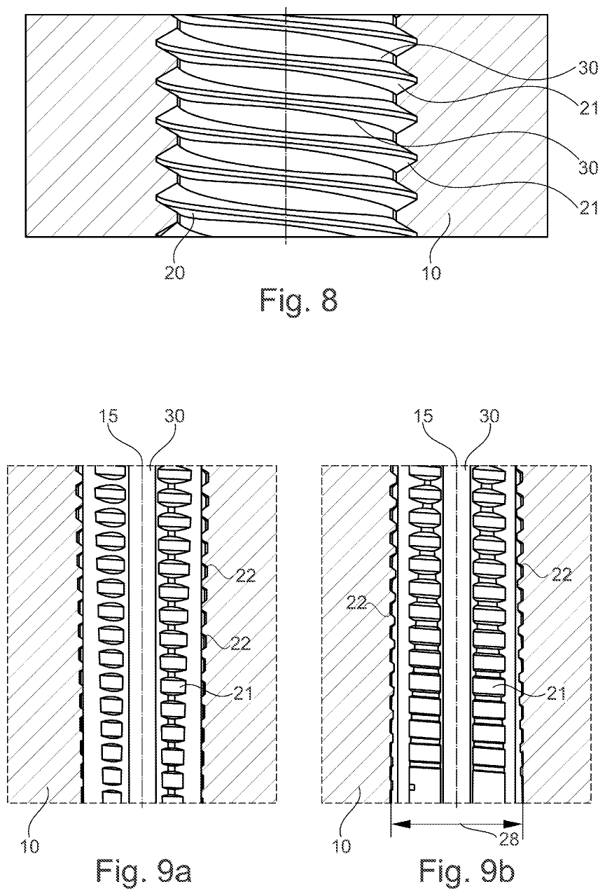

FIG. 8 shows the threaded section 20 in which the base width 26 of the thread turn 22 varies along the thread 21. Alternatively, the thread turns 22 along the thread 21 can have a different height 25 so that the flank diameter 29 of the thread 21 changes along the longitudinal axis 15 or along the circumference of the opening 13. Additionally or alternatively, the thread pitch 27 between the facing flanks 23, 23″ of the two adjacent thread turns 22 can vary along the thread 21.

FIG. 9a shows the thread 21 which has a conical shape relative to the longitudinal axis 15 of the opening 13. The thread 21 can therefore be gradually reduced or increased along the longitudinal axis 15 of the opening 13. Alternatively, the thread turn height 25 can decrease or increase along the longitudinal axis 15 without changing the outer diameter 28 of the thread 21 (see FIG. 9b).

In addition, it should be noted that “comprising” and “having” does not exclude any other elements or steps. Furthermore, it should be noted that features or steps which have been described with reference to one of the above embodiments can also be used in combination with other features or steps of other embodiments described above. Reference signs in the claims are not to be regarded as limiting.

### LIST OF REFERENCE NUMERALS

1 Threaded element
10 Body
11 First end of the body
12 Second end of the body
13 Opening
14 Inner wall
15 Longitudinal axis
20 Threaded section
21 Thread
22 Thread turn
23, 23′, 23″ Thread flank
24 Flank angle
25 Thread turn height
26 Base width
27 Thread pitch
28 Outer diameter of the thread
29 Flank diameter of the thread
30 Recess
31 Chamfer
32 Transitional section
33 Recess sections
34 Counter thread

1. A threaded element comprising or consisting of a metal having an internal thread produced by additive manufacturing, comprising:
a body;
an opening that defines an inner wall of the body, and,
a threaded section having a thread;
wherein the body comprises a first end and a second end;
wherein the opening extends at least partially from the first end toward the second end of the body;
wherein the threaded section is formed on the inner wall of the opening;
wherein the inner wall has at least one recess which crosses the threaded section; and,
wherein a surface of the threaded section has a roughness R_{z} in the range of 2.5 μm, in particular 10-25 μm.

2. The threaded element according to claim 1, wherein an outer diameter of the thread is at least 0.5 mm.

3. The threaded element according to claim 1, wherein the metal is selected from the group consisting of amorphous alloys and/or precious metals.

4. The threaded element according to claim 1, wherein the recess and/or the thread comprises a chamfer at the first end and/or second end of the body.

5. The threaded element according to claim 1, wherein the thread comprises a plurality of thread turns, wherein the thread turns have a flank angle of 10° to 70°.

6. The threaded element according to claim 1, wherein the threaded section has a conical shape relative to the longitudinal axis of the opening.

7. The threaded element according to claim 1, wherein the inner wall of the body has a plurality of recesses which extend at least partially from the first end toward the second end of the opening.

8. The threaded element according to claim 1, wherein the recess is formed helically along the threaded section.

9. The threaded element according to claim 1, wherein the recess comprises a counter thread which is formed at least partially in the opposite direction to the thread of the threaded section.

10. The threaded element according to claim 1, wherein the recess extends substantially in the longitudinal direction of the opening, wherein portions of the recess are offset in the radial direction of the opening.

11. The threaded element according to claim 1, wherein a base width of the thread turns varies along the thread.

12. A method for producing a threaded element comprising or consisting of a metal having an internal thread according claim 1, the threaded element comprising:
a body;
an opening that defines an inner wall of the body, and,
a threaded section having a thread;
the body comprising a first end and a second end;
the opening extending at least partially from the first end toward the second end of the body;
the threaded section being formed on the inner wall of the body;
the inner wall having at least one recess which crosses the threaded section; and,
a surface of the threaded section having a roughness R_{z} in the range of 2.5-60 μm, in particular 10-25 μm;
wherein the threaded element is produced using an additive manufacturing method.

13. The method according to claim 12, wherein the additive manufacturing method is selected from the group consisting of selective laser melting, selective electron beam melting, laser metal deposition and selective laser sintering.

14. The method according to claim 12, wherein the recess is designed to receive excess material from a thread turn while screwing in a screw.
